(19) United States
(12) Patent Application Publication
(10) Pub. No.: US 2026/0198435 A1
(43) Pub. Date: Jul. 16, 2026

(54) SYSTEM AND METHOD FOR THE CULTIVATION OF PLANTS

(71) Applicant: Hyswiss SA, FRIBOURG (CH)

(72) Inventor: Benoit de Combaud, FRIBOURG (CH)

(21) Appl. No.: 19/132,579

(22) PCT Filed: Nov. 24, 2023
(86) PCT No.: PCT/EP2023/083072

§ 371 Date: May 23, 2025

(30) Foreign Application Priority Data
Nov. 24, 2022 (LU) LU503106

(51) Int. Cl. A01G 31/04; A01G 31/00

(52) U.S. Cl. CPC A01G 31/045; A01G 31/008

(57) ABSTRACT

The present document describes a plant cultivation system and method for hydroculture of plants. The plant cultivation system for the cultivation of plants is disclosed in the present document. The plant cultivation system comprises a nutrient basin filled with a nutrient medium with at least one guide arranged to be mounted above the nutrient basin. One or more plant-holding structures for holding a plurality of the plants are configured to slide along the at least one guide. The plant cultivation system further comprises one or more coverings for shielding the surface of the nutrient medium from exposure to light. At least one support line can be arranged for supporting the one or more coverings above the surface of the nutrient medium.

### CROSS-REFERENCE TO OTHER APPLICATION

This application claims priority of Luxembourg patent application LU 503106, filed on 24 Nov. 2022. The entire disclosure of the Luxembourg patent application LU 503106 is hereby incorporated herein by reference.

### FIELD OF THE INVENTION

The present invention relates to a system and method for the cultivation of plants by means of a plant cultivation system, in particular a system and method for hydroculture.

### BACKGROUND OF THE INVENTION

Traditional techniques for growing plants in the open air are limited in the management of production areas. The space available for each plant is predetermined and can only be adapted as the plant grows by moving each plant individually. This process allows for plant densification but is costly and time-consuming as well as potentially harmful to the plant, as the movement induces a risk of deterioration of the plants during handling and re-planting.

In recent years, the soilless cultivation of plants (also referred to as hydroponics) has become an alternative to the traditional techniques. For example, international patent application No. WO 79/00480 A1 teaches a hydroponics growing system with provision for altering the liquid level depths in the channels of the growing system whilst producing, automatically, full aeration and nutrients intermix of the liquid within the system. The patent application discloses further information about soilless cultivation of plants and describes three types of soilless cultivation: gravel culture, nutrient film technique, and deep-water culture.

However, the same aforementioned issues regarding the process of plant densification as well as potentially harming the plant may arise for soilless plants, especially in hydroponics, where the adaptability of the production areas of the plants is only possible at the cost of manual and individual movement of each plant.

Some hydroponics systems are based on the use of a nutrient basin containing a nutrient solution. The plants are arranged on the surface of the nutrient basin in plastic supports that do not allow for easy adjustment of distances between the plants.

Another obstacle to increasing the productivity of such plant-growing systems is the exposure of the nutrient solution in the nutrient basins to natural light or an artificial light source. This light exposure increases the proliferation of algae in the nutrient basin, thereby reducing the oxygen supply for the plants, and leads to the evaporation of the nutrient solution itself. These two problems can be extremely costly for cultivation areas of up to several hectares.

International Patent Application No. WO 2017/000046 A1 describes a hydroculture device in which the plants are grown in a plurality of movable plant-holding structures in the form of gutters. A nutrient solution circulates in each of the gutters to feed the plants and the gutters can be moved along a guide so that the distance between two of the gutters can be adjusted. In addition, two types of the gutters are arranged along the guide. The first type contains plant supports that are close to each other and the first type contains a number of seedlings or small seedlings. The second type contains plant supports spaced further apart and intended to receive larger seedlings. This hydroculture device requires a manual transplantation of the plants from the first type of gutter into the second type of gutter.

CN 209 749 393 U discloses a planting unit and a planting system. Planar holders for holding plants are described and arranged within a nutrient solution carrier. The planar holders can be moved along a longitudinal direction, whereby the spacing between the planar holders is adjustable.

U.S. Pat. No. 6,370,815 B1 relates to the growth of photosynthetic organisms, such as microorganisms, algae, photosynthetic bacteria, photosynthetic organisms, and animal symbionts; higher plant tissues, and the like. A growth apparatus for the photosynthetic organisms in the form of a tube is described which is arranged within a bath. A cover can be used to maintain water temperature of the bath. The cover can be in the form of polystyrene balls or an integral sheet.

US 2016/192607 A1 discloses a hydroponic cultivation system. Plant-holding plates are used to hold plants and are disposed to span across several vessels. The vessels contain culture solution including nutrients.

CN 103 733 970 A discloses a hydroponic device comprising a hydroponic barrel, a hydroponic cup, and a cap. The hydroponic device further comprises an opaque plastic film, two bamboo strips and a plurality of small foam balls. The opaque plastic film and the foam balls are used to shield the nutrient solution from sunlight.

EP 0 133 494 A2 discloses an apparatus for growing plants contained in a plurality of elongate troughs. The elongate troughs are located in a bed section. The plurality of troughs is moved perpendicularly to the longitudinal directions of the troughs. The apparatus further comprises elevators to transfer the elongate troughs one by one between two of the bed sections.

### SUMMARY OF THE INVENTION

The present document describes a system and method for hydroculture and cultivation of plants.

The plant cultivation system comprises a nutrient basin provided with a nutrient medium, such as a fluid or a mist medium, with at least one guide arranged to be mounted above the nutrient basin. The at least one guide comprises one or more portions arranged parallel to the surface of the nutrient medium, or at a slope angle for increasing a vertical distance between the surface of the nutrient medium and the at least one guide. One or more plant-holding structures for holding a plurality of the plants are configured to slide along the at least one guide. The at least one guide comprises a displacement device for moving at least one of the one or more plant-holding structures and adjusting a distance between the one or more plant-holding structures. The distance is and be adjusted and is dependent on the growth of the plants. The plant cultivation system further comprises one or more coverings for shielding the surface of the nutrient medium from exposure to light.

The spacing of the system enables a large-scale cultivation of plants in a cost-effective manner. The precise spacing between the plant-holding structures with the plants is adjustable dependent on the degree of growth of the plants. The coverings reduce substantially the amount of light reaching the nutrient medium and thus eliminate substantially the growth of algae in the nutrient medium and reduce evaporation.

The plant cultivation system may further comprise, in one aspect, at least one first support line for supporting the one or more coverings. The at least one first support line is arranged above the surface of the nutrient medium. The coverings can be evenly supported by using the first support lines above the surface of the nutrient medium. The first support lines help to reduce the amount of algae and bacteria growth on the coverings as there will be no contact (or at least very little contact) between the coverings and the surface of the nutrient medium.

In a further aspect, at least one second support line for supporting the one or more coverings is configured to be arranged above the one or more coverings.

The at least one second support line is mounted above the coverings and, thus, contributes to better guidance of the coverings during displacement of the plant-holding structures. The better guidance of the coverings is beneficial, in particular, for coverings exhibiting a foldable structure, since the better guidance improves folding/unfolding of the coverings.

The slope angle of the at least one guide thus provides a possibility for controlling the degree of irrigation of the plants because the vertical distance determines the depth to which the roots need to reach into the nutrient medium. An irrigation process of the plants 50 can be performed from the bottom, i.e., irrigation to the roots of the plants 50. The irrigation to the roots of the plants 50 rather than from the top of the plants 50 has a positive impact on the growth of the plants 50. The irrigation to the roots of the plants 50, for example, causes less stress for the plants 50, reduces the risk of diseases, decreases fungus development on the leaves, and reduces the complexity of the irrigation process itself.

The plants 50 have different types of roots such as a first type of roots for supporting the plants 50 in the soil, a second type of roots for providing nutrients to the plants 50, and a third type of roots for providing oxygen to the plants 50. The third type of roots are also referred to as “aerial roots”. The aerial roots die when kept in the nutrient medium 12 for too long. The irrigation process, as explained above, i.e., irrigation to the roots of the plants 50, may also comprise a provision of an air chamber between the surface of the nutrient medium 12 and the one or more portions of the at least one guide 20. The air chamber is beneficial for the aerial roots of the plants 50 and enables greater growth of the plants 50, for example bigger leaves. The greater growth of the plants contributes to an increased productivity of the plant cultivation system, i.e., larger crops.

In a further aspect, the air chamber is implemented with respect to the one or more portions of the at least one guide. In one example of the further aspect, a first portion of the at least one guide is parallel to the surface of the nutrient medium and a second portion of the at least one guide exhibits the slope angle. The vertical distance between the surface of the nutrient medium and the at least one guide increases along the second portion and, thus, forms the air chamber. The air chamber means that the nutrient medium does not contact the aerial roots. In other words, the plants which have already longer roots are arranged such that the aerial roots are located within the air chamber but the second type of roots for providing nutrients can reach into the nutrient medium. In the one example of the further aspect, the plants exhibiting shorter roots, i.e., younger plants with almost no or very short aerial roots, may be located in the first (parallel) portion of the at least one guide. The younger plants can then reach the nutrient medium.

In a further aspect, the plant cultivation system may further comprise at least one buffer basin and at least one pump for changing a level of the surface of the nutrient medium. The changing of the level of the nutrient medium enables flexibility regarding the irrigation process of the plants such as, but not limited to, the irrigation of the plants with a first level of the surface of the nutrient medium for a first period of time and with a second level of the surface of the nutrient medium for a second period of time.

In a further aspect, the plant cultivation system may further comprise at least one of a gauge or a pressure sensor for measuring a height of the level of the surface of the nutrient medium. The measuring of the height enables an accurate changing of the level of the surface of the nutrient medium.

In a further aspect, the plant cultivation system may be configured such that the guides are adapted to comprise an accommodating guide for accommodating the displacement device and at least two support guides. The at least two support guides are arranged adjacently to the accommodating guide for supporting the one or more plant-holding structures. The displacement device may use a modified engagement element constructed with a large width extending perpendicular to the direction of movement. The moving of the plant-holding structure by means of the modified engagement element requires only one displacement device which reduces complexity and saves costs.

In a further aspect, the plant cultivation system may be configured such that the guides are adapted to comprise at least one of a first guide comprising a first displacement bar and at least one of a second guide comprising a second displacement bar. The displacement device comprises a first plurality of displacement devices mounted on the first displacement bar and a second plurality of displacement devices mounted on the second displacement bar. The plant cultivation system may further comprise a drive shaft coupled to the first displacement bar and the second displacement bar, and a motor coupled to the drive shaft for driving the drive shaft. The drive shaft moves the first displacement bar and the second displacement bar in a synchronized manner. Using a driving mechanism comprising the motor, the drive shaft, as well as the first displacement bar and the second displacement bar enables a synchronization of the first plurality of displacement devices and the second plurality of displacement devices such that horizontal rotation of the plant-holding structures can be avoided during movement.

In a further aspect, the one or more plant-holding structures are equipped with one or more plant-holding modules for holding the plants. These plant-holding modules are configured to be an integral part of the plant-holding structure and are formed from a perforated part of the plant-holding structure bent downwards. The plant-holding modules are arranged so that the roots of the plant are located below the bottom part of the plant-holding modules. This arrangement with the location of the roots facilitates harvesting of the plants and enables the avoidance of contact (and thereby contamination) between the coverings and the surface of the nutrient medium.

In a further aspect, the one or more plant-holding structures further comprise one or more guiding elements. It will be noted that the guiding elements are part of the plant-holding structures and are not to be confused with the guides onto which the plant-holding structures are placed, as discussed above. Such guiding elements ensure that the first support lines are kept close to the plant-holding structures and are held above the surface of the nutrient medium. The guiding elements may also avoid entanglement of the first support lines in the case, for example, the first support lines are provided in a very close arrangement to each other. These guiding elements are configured to be an integral part of a plant-holding structure and can be formed from a perforated part of the plant-holding structure bent downwards to form a hook-like structure which hooks around the first support line.

In a further aspect, a number of the guides arranged in a first region of the nutrient basin is different to a number of the guides arranged in a second region of the nutrient basin. The number or density of guides may vary within different regions of the nutrient basin. A larger number of guides supporting the plant-holding structures will result in a more stable structure and restrict the plant-holding structures from bending. The bending of the plant-holding structures may result in a scenario in which some of the plants are lowered towards the surface of the nutrient medium and other ones of the plants are lifted away from the nutrient medium. In a lifted position, the roots of the plants (especially of the younger plants) may then not reach the nutrient medium.

In a further aspect, the one or more guides comprise a displacement device for moving the one or more plant-holding structures. The displacement device comprises a moveable engagement element for engagement with the plant-holding structures. The displacement device allows users to control the spacing between the plant-holding structures with a high degree of accuracy. The one or more coverings are attached to the one or more plant-holding structures so that the coverings are displaceable along at least one guide.

In a further aspect, the plant cultivation system further comprises a controlling motor for pulling a cable loop, and a tension unit for providing a tension force to the cable loop. This configuration enables the displacement device to move along the guides and to adjust distances between the one or more plant-holding structures. The controlling motor is controlled by a computer and allows users to provide automatic spacing routines between the plant-holding structures. This spacing routine is adaptable, for example, to the growth rates of certain plants.

In a further aspect, the one or more first support lines are parallelly arranged to the guides. A parallel arrangement facilitates the sliding of coverings over the one or more first support lines.

In a further aspect, the one or more plant-holding modules are configured to hold a plant so that the plant is feedable from the nutrient medium of the nutrient basin. A plurality of plant-holding modules enables the cultivation of many plants in a single nutrient basin at the same time.

In a further aspect, the coverings exhibit a foldable structure and can be made of at least one of plastics, aluminized paper, stainless steel, aluminium, or aluminized plastic. The foldable structure exhibits a sufficient stiffness to enable a reliable folding/unfolding process. The aluminized paper also reflects heat to improve insulation of the nutrient medium.

The nutrient medium can comprise a fluid or a mist. The present document also describes a first method using the plant cultivation system for hydroculture of the plants. The method for the cultivation of plants in a nutrient medium provides in a first step a plurality of plants in the plant-holding modules of the plant-holding structures. The plant-holding structures are then integrated into the plant cultivation system so that the plant-holding structures are moved from one side of the nutrient basin towards the opposite side during the growth of the plants. In a next step, the one or more plant-holding structures are slid above the nutrient medium along at least one guide. The distances between the one or more plant-holding structures are then adjusted dependent on the growth of the plants. The sliding is performed by a displacement device. The one or more coverings are being moved above a surface between the plant-holding structures. The coverings shield the surface of the nutrient medium from exposure to light with the one or more coverings.

The present document also describes a method using the plant cultivation system for hydroculture of the plants. The method for the cultivation of plants in a nutrient medium comprises in a first step harvesting a plurality of the plants located in one or more plant-holding structures. In a next step, the harvested ones of the one or more plant-holding structures are removed from at least one guide. Subsequently, the unharvested ones of the one or more plant-holding structures are slid above the nutrient medium along the at least one guide. The distances between the one or more plant-holding structures are then adjusted dependent on the extent of growth of the plants. The sliding is performed by a displacement device. The one or more coverings are moved above a surface between the one or more plant-holding structures. In a further step, the plurality of plants is provided in plant-holding modules of the one or more plant-holding structures. The plant-holding structures are then integrated into the plant cultivation system so that the plant-holding structures are moved from one side of the nutrient basin towards the opposite side during the growth of the plants.

The methods further comprise changing a level of the surface of the nutrient medium in the nutrient basin. This procedure is actively used to promote development of the roots of plants (in particular for younger plants such as seedlings) during the first days and weeks of the growth cycle of the plants.

The methods further comprise engaging using a displacement device with the one or more plant-holding structures. The displacement device is displaced along the at least one guide and therefore enables control of the spacing between the plant-holding structures.

The methods are implemented using a computer program located in a software controller. Users/growers can individually modify the computer program and, thus, program the positions of the displacement device. The computer program allows users to control the spacing between adjacent plant-holding structures over time.

### DESCRIPTION OF THE FIGURES

FIG. 1A shows a schematic top view of a plant cultivation system for the cultivation of plants.

FIG. 1B shows a schematic top view of a plant cultivation system for the cultivation of plants with two regions.

FIG. 2A shows a cross-section of a plant-holding module of the cultivation system.

FIG. 2B shows a side view of a portion of a plant-holding structure with a guiding element and a first support line.

FIG. 2C shows a cross-section of a plant-holding module of the cultivation system with a guide and first and second support lines below and above the coverings.

FIG. 2D shows a cross-section of a plant-holding module of the cultivation system with a guide exhibiting a slope angle.

FIG. 3A shows a schematic illustration of a displacement device with an engagement element.

FIG. 3B shows a displacement device movable within a guide by means of a controlling motor, a cable loop, and a tension unit.

FIG. 3C shows a schematic top view of a displacement device comprising displacement bars movable within guides by means of a motor and a drive shaft.

FIG. 3D shows a side view of a displacement device comprising displacement bars movable within guides by means of a motor and a drive shaft.

FIG. 4 shows a side view of a guide and plant-holding structures of a plant cultivation system of FIG. 1A.

FIG. 5 shows a flow chart describing a method for a plant cultivation system to cultivate plants.

FIG. 6 shows a flow chart describing a method for a plant cultivation system to cultivate plants.

FIG. 7 shows a schematic illustration of a nutrient basin and a buffer basin for adding or removing a nutrient medium.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

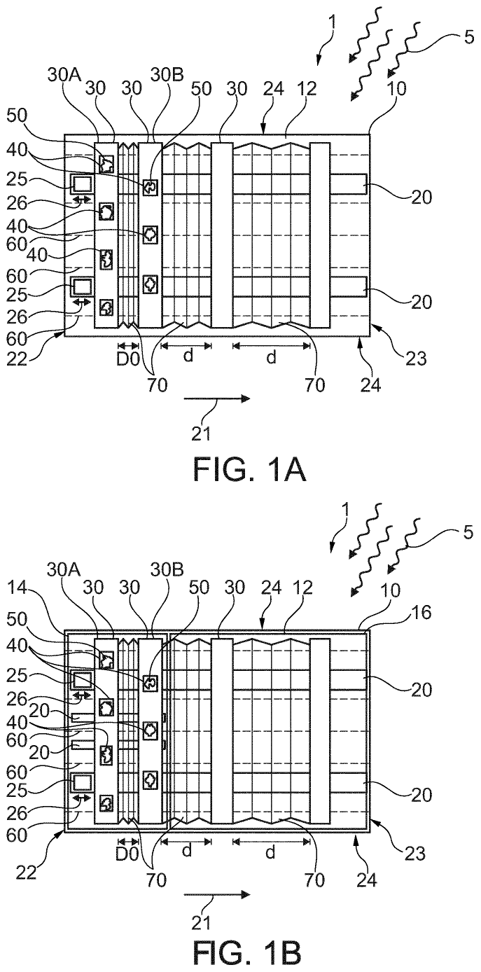

FIG. 1A shows a top view of a plant cultivation system 1 for cultivating plants 50 according to one aspect. The plants 50 in this context may comprise both crops (such as, but not limited to, lettuce, tomatoes, and cabbage.) and ornamental plants. The cultivation system 1 comprises a nutrient basin 10 filled with a nutrient medium 12 used to grow and feed the plants 50. The nutrient basin 10 comprises a first edge 22 and a second edge 23. The first edge 22 is on the opposite side of the second edge 23.

Transverse plant-holding structures 30 are provided at the first edge 22 with younger plants 50 and are moved over time towards the second edge 23, as the plants 50 grow. The direction of movement, i.e., from the first edge 22 to the second edge 23, is referred to as longitudinal direction 21. The nutrient basin 10 further comprises lateral sides 24. There may be a plurality of nutrient basins 10 which are adjacently arranged or dividing the nutrient basin 10 into multiple sections. Ones of the multiple sections may contain a different nutrient medium 12 and the section(s) can be cleaned independently from the other sections. The size of the nutrient basin 10 is limited only by the practicability of the size of the plant-holding structures 30 and the volume of the nutrient basin 10. In one non-limiting aspect, the nutrient basin 10 has a length in the range of 20 m to 100 m, a width in the range of 10 m to 15 m, and a height (depth) of about 0.3 m. It will be understood that other dimensions with respect to the length, the width, and the height may also be used. In a further aspect, the nutrient basin 10 is located in a greenhouse. The size and construction (e.g., distance between pillars) of the greenhouse limits the dimensions of the nutrient basin 10 and the plant-holding structures 30.

The plant-holding structures 30 are arranged at the first edge 22 with an initial distance D0 from the next plant-holding structure 30. The initial distance D0 may be approximately the width of a young plant 50, for instance a seedling.

Guides 20 are arranged to be mounted above the nutrient basin 10 above the surface of the nutrient medium 12 and provided parallel to the lateral sides 24 of the nutrient basin 10. FIG. 1A shows two guides 20 but this is not limiting of the invention, and it is noted that another aspect can comprise one or more than two guides 20. One particular aspect could comprise, for example, a different number of guides 20 between a first region close to the first edge 22 of the nutrient basin 10 where plant-holding structures 30 holding younger plants 50 are arranged and a second region of the nutrient basin 10 where older plants 50 are located, as shown in FIG. 1B. Adjacent ones of the guides 20 arranged in the first region exhibit a first spacing and adjacent ones of the guides 20 arranged in the second region exhibit a second spacing such that the first spacing is smaller than the second spacing. The first spacing enables a better support of the plant-holding structures 30. The better support may prevent bending of the plant-holding structures 30 in between the adjacent ones of the guides 20. The two guides 20 in FIG. 1A may also be positioned differently than in a parallel manner. The guides 20 are configured to support a plurality of plant-holding structures 30 during their travel along the direction 21 from the first edge 22 to the second edge 23. The guides 20 have a U-shaped cross-section and accommodate a displacement device 25. The U-shaped cross-section facilitates cleaning of the guides 20. The displacement device 25 is able to run along the length of the guides 20. It is noted that not all of the guides 20 need to exhibit a U-shaped cross-section and that not all of the guides 20 accommodate the displacement device 25. It is noted that two or more of the displacement devices 25 may run along the length of the guides 20 and may exhibit a synchronized behaviour.

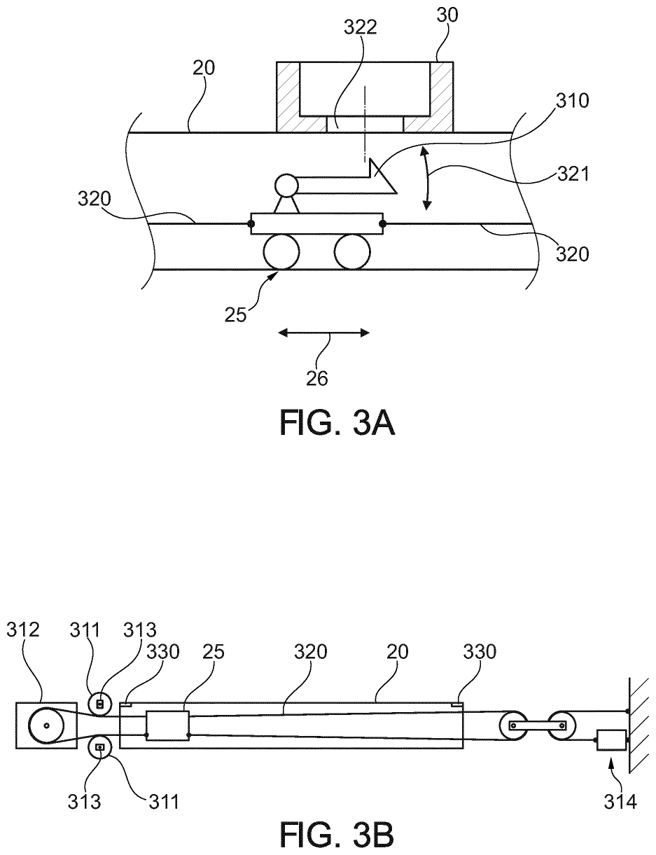

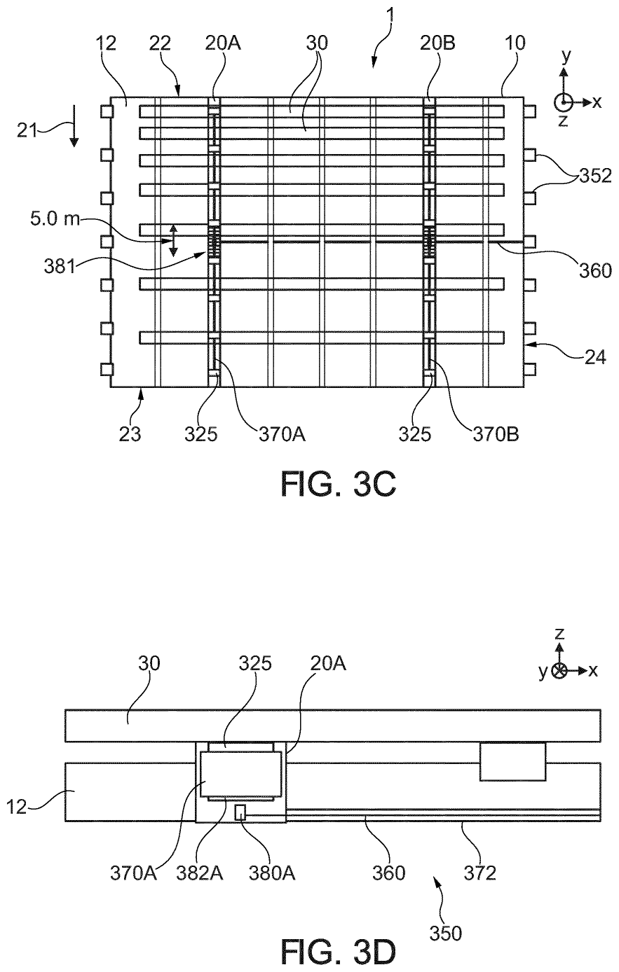

The displacement devices 25 are used to move plant-holding structures 30 individually. The displacement devices 25 move along the direction of movement 26 and stop at designated positions in order to engage with one of the plant-holding structures 30. The engagement element 310 for engaging with a single plant-holding structures 30 is illustrated in more detail in FIG. 3A.

The plant-holding structure 30 comprises a plurality of plant-holding modules 40. The plant-holding structure 30 and/or the plant-holding modules 40 may have a U-shaped cross-section. Such a shape, or any other shape which is open and accessible from above, for holding plants 50 simplifies cleaning and facilitates the process of placing the plants 50 (in the form of seedlings) into the plant-holding modules 40. The plant-holding module 40 provides an accommodating space to place one of the plants 50 so that the plant 50 is able to put down roots into the nutrient medium 12 in the nutrient basin 10. The plant-holding module 40 can further be arranged so that the lower part (e.g., roots 50 within a ball of soil/substrate) is placed below the bottom part 250 of the plant-holding module 40. The plant-holding modules 40 may be distributed along the long edge of the plant-holding structures 30 equidistantly and/or with varying distances. The adjacent plant-holding structures 30 exhibit a staggered disposition of the plant-holding modules 40. The staggered disposition of the plant-holding modules 40 requires two types of the plant-holding structures 30, namely, a plant-holding structures 30 with a first plant-holding arrangement 30A and a plant-holding structure 30 with a second plant-holding arrangement 30B. The two types of the plant-holding structures 30 are configured so that, for example, each of the plant-holding module 40 of the second plant-holding arrangement 30B is located in between two plant-holding modules 40 of the first plant-holding arrangement 30A. One example of the staggered disposition is shown in FIG. 1A. Both types of the plant-holding structures 30 may be marked, for example, with coloured end caps to ensure that newly arranged plant-holding structures 30 at the first edge 22 of the nutrient basin 10 exhibit the correct plant-holding arrangement of plant-holding modules 40 and the correct orientation. FIG. 1A shows plant-holding structures 30 which have substantially the same length as the width of the nutrient basin 10 between the two lateral sides 24 of the nutrient basin 10.

Coverings 70 are provided between two adjacent ones of the plant-holding structures 30. The coverings 70 shield the surface of the nutrient medium 12 from exposure to light 5. The plant cultivation system 1 needs to be exposed to light 5, for example to sunlight and/or to artificial light to enable the growth of the plants 50. The exposure to the light 5 also results, for instance, in the growth of algae within the nutrient basin 10. The presence of algae consequently affects the cultivation of plants 50 and the purity of the nutrient medium 12. The exposure to the light 5 may also enable the growth of bacteria and/or fungi which also affect the cultivation of plants 50 and the purity of the nutrient medium 12. The coverings 70 are hence intended to shield the surface of the nutrient medium 12 from exposure to the light 5. Furthermore, the coverings 70 reduce the evaporation of the nutrient medium 12 from the nutrient basin 10.

The coverings 70 may be attached to one or both of two adjacent plant-holding structures 30. The coverings 70 may also be attached to the plant-holding structure 30 and one side of the nutrient basin 10, for example the first edge 22, when the plant-holding structure 30 is newly introduced to the nutrient basin 10. As soon as another plant-holding structure 30 is introduced to the nutrient basin 10, the attachment of the coverings 70 of the plant-holding structure 30 to the first edge 22 needs to be removed. The material of said coverings 70 is in one aspect a fabric and is configured to provide a foldable structure that unfolds when the distance d between two adjacent plant-holding structures 30 increases.

It will be noted that other materials may also be used to implement the foldable structure of the coverings 70, such as, but not limited to, plastics, aluminized paper, stainless steel, aluminium, or aluminized plastic. The aluminized paper, for example, can exhibit a sufficient stiffness to enable the folding/unfolding process and reflects heat to enable insulation of the nutrient medium 12. The coverings 70 may also be made of an elastic material that expands when the distance d between two adjacent plant-holding structures 30 increases.

In one aspect, one edge of the covering 70 is attached to a long edge of the plant-holding structures 30 and the other edge has a long rod, made for example from copper, steel or aluminium, to support the covering 70. The long rod provides an additional weight. The long rod, for example, thereby facilitates the unfolding process of the coverings 70 when the plant-holding structure 30 is moved and the distance d between two adjacent plant-holding structures 30 is increased. The long rod also facilitates the folding process of the coverings 70 when the long rod is moved by the displacement of the adjacent plant-holding structure 30. Several coverings 70 arranged one next to the other can be used to shield the surface of the nutrient medium 12 between adjacent ones of the plant-holding structures. In a further aspect, one or more coverings 70 are used to shield the surface of the nutrient medium 12 of the nutrient basin 10 only partially.

The cultivation system 1 further comprises a plurality of first support lines 60 for supporting the coverings 70 above the surface of the nutrient medium 12. The first support lines 60 are stretched from the first edge 22 to the second edge 23 and mounted above the surface of the nutrient medium 12. The first support lines 60 are parallelly arranged in FIG. 1A to the lateral sides 24 of the nutrient basin 10 and/or the guides 20. The support provided by the first support lines 60 enables the avoidance of contact (and thereby contamination) between the coverings 70 and the surface of the nutrient medium 12.

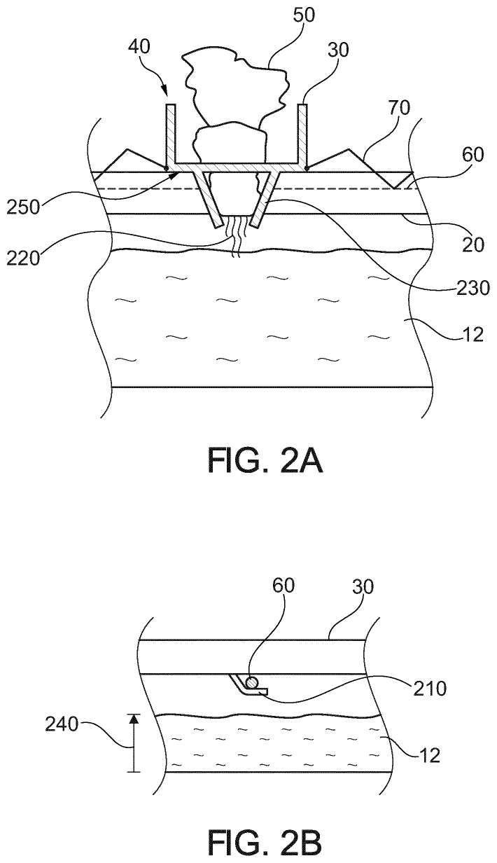

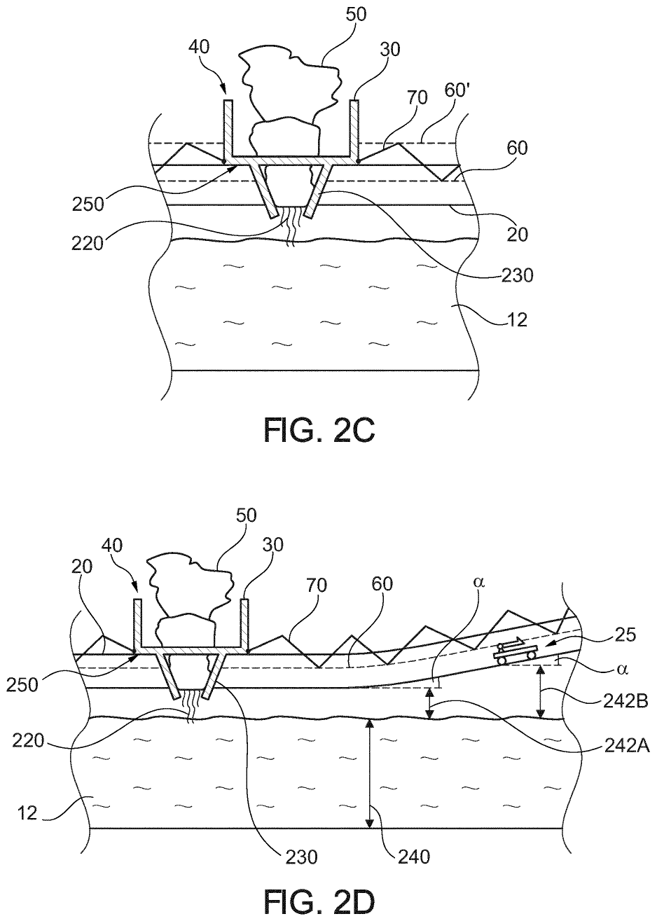

FIG. 2A shows a cross-section of a plant-holding module 40. The plant-holding module 40 is part of a plant-holding structure 30, shown in FIG. 1A, and provides an accommodating space for a plant 50. The plant-holding module 40 can be implemented, for example, by attaching a suitable holder to or by being an integral part of the plant-holding structure 30. FIG. 2A also shows how the lower part of a plant 50 (usually a ball of earth with roots, also referred to as “peat”, or the like (e.g. organic or synthetic foam)) is situated within a plant-holding module 40. The module in FIG. 2A is provided as an integral part of a U-shaped plant-holding structure 30 and the plant 50 is held therein by two holding elements 230. The holding elements 230 in this aspect are formed from a perforated part of the plant-holding structure 30 bent downwards. The bending angle of the holding elements 230 ensures that the plant 50 is sufficiently held in place and enables the roots 220 to grow downwards and feed from the nutrient medium 12. In a further aspect, the holding elements 230 may exhibit a more complex shape, for example by subdividing each of the holding elements 230 into several elements, so that the lower part of a plant 50 is more exposed to the nutrient medium 12. FIG. 2A further shows that the guides 20 and the first support lines 60 are mounted above the surface of the nutrient medium 12. The covering 70 are thus spaced above the nutrient medium 12.

In a further aspect of the invention, no holding elements 230 are provided. The bottom part 250 of the plant-holding module 40 is thus flat.

FIG. 2B shows a side view of a portion of the plant-holding structure 30 with a guiding element 210 and the first support line 60. The guiding element 210 is provided as an integral part of a plant-holding structure 30 and is formed from a perforated part of the plant-holding structure 30 bent downwards to form a hook-like structure. FIG. 2B further shows that the first support lines 60 are provided above the surface of the nutrient medium 12 by being placed on the guiding element 210.

In a further aspect of the disclosure, the coverings 70 are supported by two support lines. As can be seen in FIG. 2C, the first support line 60 is mounted to support the one or more coverings 70 from underneath, i.e., the one or more coverings 70 are placed onto the first support line 60. A second support line 60′ is mounted above the one or more coverings 70. The arrangement of the first and second support lines 60, 60′, sandwiching the one or more coverings 70, enables a better guidance of the coverings 70 during the displacement of the plant-holding structures 30. The arrangement of the first and second support lines 60, 60′ is beneficial for those foldable coverings 70 exhibiting a foldable structure (also termed “concertina-like”), since the arrangement improves the folding/unfolding process of such foldable coverings 70.

In a further aspect of the disclosure, the at least one guide 20 may comprise one or more portions. The portions of the guide 20 may be arranged in a plane parallel to the surface of the nutrient medium 12 or at a slope angle a relative to the surface of the nutrient medium 12, see FIG. 2D. A first vertical distance 242A and a second vertical distance 242B may be defined at the one or more portions of the guide 20 with the slope angle α. The second vertical distance 242B is larger than the first vertical distance 242A, i.e., exhibiting a difference in vertical height, which means that a vertical distance between the surface of the nutrient medium 12 and the guide 20 increases along the guide 20.

In a further aspect of the disclosure, a level of the surface 240 of the nutrient medium 12 may be changed. The change of the level of the surface 240 of the nutrient medium 12 enables control of the irrigation of the plants because the vertical distance determines the depth to which the roots 220 need to reach into the nutrient medium 12.

The difference in vertical height may also be used for another aspect of the invention. The displacement device 25 is positioned at a waiting position as long as the one or more plant-holding structures 30 are not moved. The waiting position of the displacement device 25 may be chosen with respect to the level of the surface 240 of the nutrient medium 12 and a predetermined value of the second vertical distance 242B (for example, but not limited to, 50 mm).

In one example, the level of the surface 240 of the nutrient medium 12 is changed so that the level 240 reaches the bottom part 250 of the one or more plant-holding structures 30. Some of the nutrient medium 12 may then flow into the at least one guide 20. The level of the surface 240 of the nutrient medium 12 may also be changed such that one of the one or more portions of the at least one guide (20) are (completely) flooded for a period of time (e.g. 6 hours per day), i.e., the level of the surface 240 of the nutrient medium 12 is set to be above the one of the one or more portions of the at least one guide (20). If the waiting position of the displacement device 25 is defined by the predetermined value of the second vertical distance 242B, the displacement device 25 is located above the surface of the nutrient medium 12 and prevents contact of the nutrient medium 12 with the displacement device 25. The contact of the nutrient medium 12 with on-board electronics of the displacement device 25 may cause damage to the on-board electronics. The waiting position with respect to the second vertical distance 242B thus enables a greater degree of flexibility with respect to the change of the level of the surface of the nutrient medium 240, i.e., the irrigation process of the plants 50.

In yet another aspect of the invention, the chosen waiting position of the displacement device 25 may be input, for example, to a software controller (i.e., a control device). The software controller may be, for example, but not limited to, a programmable logic controller (PLC). The PLC is programmed based on the input regarding the chosen waiting position so that the displacement device 25 automatically returns to the waiting position after the displacement of the one or more plant-holding structures 30. The PLC may also be programmed so that the displacement of the one or more plant-holding structures 30 is only executed when the level of the surface of the nutrient medium 240 is at a predefined level.

FIG. 3A shows a schematic illustration of a displacement device 25 with an engagement element 310. The displacement device 25 is accommodated within the guide 20. As previously noted, the displacement device 25 moves within the guide 20 along the direction of movement 26 and stops at predetermined positions for engaging with plant-holding structures 30. The engagement element 310 can be, for instance, a hook-like element, as seen in FIG. 3A. Such a hook-like element is then pivotably mounted on the displacement device 25 and is configured to provide rotatory movements according to the engagement direction 321. The engagement direction 321 of the engagement element 310 is characterized in two states: The lower state, depicted in FIG. 3A, allows the displacement device 25 to move within the guides 20 without engaging to the plant-holding structures 30. The upper state allows engagement so that the engagement element 310 establishes contact with a plant-holding structure 30. A designated contact area for a hook-like element can be provided for example by an opening 322 in the bottom part of the plant-holding structure 30. The engagement element 310 in the upper state can engage with the plant-holding structure 30 and the plant-holding structure 30 is moved according to the movement of the displacement device 25. The force to move the displacement device 25 and thus the plant-holding structure 30 is provided by a cable loop 320 located within the guide 20.

It will be noted that, in another aspect, the displacement device 25 may also be equipped with further electronic devices, such as sensors, actuators, and communication devices (e.g., by cable or wireless), that enable autonomous control of the displacement device 25 without the cable loop 320. These additional electronic devices may also be used to improve safety and/or reliability of the plant cultivation system during operation of the displacement device 25, as discussed with respect to FIG. 3A. Additional sensors like optical devices, for example, may be used to check whether the displacement device 25 is in the correct position relative to the plant-holding structure 30 before the engagement element 310 engages with the plant-holding structure 30. In the case in which the optical devices detect that the displacement device 25 is incorrectly positioned relative to the plant-holding structure 30, feedback can be provided, for example, to the PLC or a computer and further actions can be implemented, such as outputting alarm signals, pausing of automatic spacing routines, or providing prompts demanding user input. The optical devices may also be used to read, for example, QR codes attached to the plant-holding structures 30 in order to ensure that the correct plant-holding structure 30 is moved.

The engagement element 310 in FIG. 3A can further comprise an additional device that keeps the engagement element 310 in the upper state but also enables rotatory movements towards the lower state. Such a device may be, for example, a controllable spring (not shown in FIG. 3A). The displacement device 25 is then able to move in one direction without engaging to the plant-holding structures 30, for example to the right side with respect to the direction of movement 26 in FIG. 3A. Moving in the opposite direction enables engagement with the plant-holding structure 30.

In a further aspect of the invention, the plant cultivation system 1 may further comprise an additional device for providing electric power to the displacement device 25. The additional device may comprise a follower shuttle. The follower shuttle, for example, moves in the at least one guide 20 in a synchronized manner with the displacement device 25 so that the follower shuttle provides an electric cable to the displacement device 25. The follower shuttle may also be installed in a parallel arrangement next to the displacement device 25 by means of an additional guide 20 which is implemented solely for the follower shuttle.

In a yet further aspect of the invention, the electric cable may be provided to the displacement device 25 with a cable chain. The cable chain is parallelly arranged to the guide 20 accommodating the displacement device 25. The cable chain is attached at one end to the displacement device 25. The cable chain avoids that strain/tension which may be caused by the movement of the displacement device 25 is applied to the electric cable.

In a further aspect of the invention, the rotatory movements of the engagement element 310, as discussed with respect to FIG. 3A, may be achieved by using, for example, but not limited to, an electromagnet. The electromagnet generates a force or torque so that the engagement element 310 may be positioned either in the lower state or the upper state. The electromagnet may comprise a solenoid. The control of the electromagnet and the engagement element 310 is executed, for example, by the PLC. The electromagnet enables a simple and flexible setup for controlling the engagement element 310.

In a yet further aspect of the invention, the displacement device 25 comprises a monitoring sensor for monitoring the position of the engagement element 310. The monitoring sensor provides position data about the position of the engagement element 310. In one example, the PLC may evaluate the position data provided by the monitoring sensor and determines whether the engagement element 310 is in the correct position, i.e., in the lower state or in the upper state. The monitoring sensor may be, for example, but not limited to, an inductive sensor, a mechanical sensor, or an optical sensor. It will be appreciated that other sensors may also be applicable to determine two different positional states.

FIG. 3B shows the displacement device 25 in more detail. The displacement device 25 is moved within the guide 20 by a controlling motor 312. The controlling motor 312 is controlled by a computer program and drives the cable loop 320. Both ends of the cable loop 320 are attached to the displacement device 25 at opposite sides. The displacement device 25 is moved along the guide 20 in dependence of the rotational direction of the controlling motor 312. A tension unit 314 is provided for maintaining the tension in the cable loop 320. The tension unit 314 can comprise, for example, an additional device which uses weights to provide a tension force to the cable loop 320. The displacement device 25 further comprises one or more angle sensor units 313 to determine rotational angles of a wheel 311 to calculate the positions of the plant-holding structures 30 within the nutrient basin 10 and thus adjust distance d between the plurality of plant-holding structures 30 in one direction. It is understood that there exist other methods that can also be used to drive a cable and to determine the distance travelled by the displacement device 25.

In a further aspect, end sensors 330 are provided at each end of the guide 20 to indicate when the displacement device 320 has reached the end of the guide 20, i.e., the first edge 22 and the second edge 23. This enables a recalibration of the distances d by a control unit as the cable loop 320 elongates over time. It will be appreciated that the cable loop 320 should be sufficiently thick, e.g., 3-5 mm, to ensure that such elongation is kept to a minimum. The end sensors 330 may also be used to activate or deactivate the engagement element 310. Deactivation refers to the state where the engagement element 310 is permanently in the lower state and does not engage with any plant-holding structure 30.

In a further aspect of the invention, the plant cultivation system 1 comprises a localization device for determining the precise position of the displacement device 25. The localization device may be, for example, but not limited to, a wheel encoder contacting a driving cable. The driving cable drives the displacement device 25. The driving cable may, for example, be the cable loop 32, as discussed with respect to FIGS. 3A and 3B. The wheel encoder may be located on a tensioned portion of the driving cable, for example, close to a drive pulley. The wheel encoder comprises a measuring wheel which rotates with respect to the movement of the driving cable. The wheel encoder calculates the position of the displacement device 25 based on a defined calculation routine with respect to the rotations of the measuring wheel. The measuring wheel may be calibrated and designed to limit slippage of the cable. The wheel encoder may be configured to provide measured data to the PLC for processing the measured data and calculating the precise position of the displacement device 25. The calculation of the precise position may be performed in real time.

It will be appreciated that other localization devices may be implemented such as, but not limited to, a linear magnetic encoder, an encoder with an on-board measuring wheel, optical pulse counting system with an on-board measuring wheel, laser range finder, or an encoder of the controlling motor 312, such as the angle sensor unit 313, as discussed with respect to FIGS. 3A and 3B, in combination with an implementation of reference devices (e.g., sensors). The reference devices may be implemented at fixed positions along the guides 20. The reference devices may be, for example, but not limited to, an inductive or mechanical sensor. The reference devices may detect passing ones of the displacement device 25 and generate corresponding detection data. The detection data may then be used for correcting an offset in the position of the displacement device 25 obtained by the encoder. The localization device may also be implemented by radio-frequency identification (RFID). The displacement device 25 may then comprise a transmitter and a radio receiver (RFID sensor). A plurality of radio transponders (RFID tags) may be positioned along the at least one guide 20. The transmitter sends a radio signal. Upon receiving the radio signal, the plurality of radio transponders emits a unique signal. The unique signal is received by the radio receiver. The radio receiver communicates the received unique signals, for example, to the PLC for identifying the positions of the corresponding RFID tags.

In a further embodiment, the plant cultivation system 1 employs one displacement device 25. The plant cultivation system 1 further comprises two or more sliding support devices for the plant-holding structures 30. The two or more sliding support devices are attached to each one of the plant-holding structures 30. The two or more sliding support devices may also be described as “skis”. In one example, the two sliding support devices comprise two elongated sliding elements. The two elongated sliding elements slide on corresponding rails which are arranged parallel to the guide 20 accommodating the one displacement device 25. The two elongated sliding elements prevent the plant-holding structure from horizontally rotating during the displacement.

In a yet further embodiment, a displacement device 25 is provided with a modified engagement element. The modified engagement element is not formed by a hook-like element as discussed with respect to FIG. 3A. The modified engagement element is constructed with a width extending perpendicular to the direction of movement 26. The width has a dimension so that horizontal rotation of the plant-holding structures is avoided during the displacement. In one non-limiting example of the yet further embodiment, the guides 20 of the plant cultivation system 1 are adapted to comprise an accommodating guide for accommodating the displacement device 25 and at least two support guides. The at least two support guides are arranged adjacently to the accommodating guide for supporting the one or more plant-holding structures 30. The height of the accommodating guide is smaller than the height of the at least two support guides which enables provision of the modified engagement element. The width of the modified engagement element may be, for example, but not limited to, 1 m. It will be understood that the width may also be smaller than 1 m or larger than 1 m. The modified engagement element may be used for pushing and/or pulling of the plant-holding structures 30 in order to achieve the displacement.

In a yet further aspect of the invention, a displacement of the one or more plant-holding structures is achieved by a driving mechanism 350 using no cables, see FIGS. 3C and 3D. The plant cultivation system 1 comprises the nutrient basin 10 with the nutrient medium 12. A first guide 20A and a second guide 20B are mounted above the nutrient basin 10. The first guide 20A and the second guide 20B have the U-shaped cross-section, as discussed with respect to FIG. 1A. It is noted that further guides 20 without the U-shaped cross-section may be used for supporting the one or more plant-holding structures 30. The first guide 20A and the second guide 20B extend from the first edge 22 to the second edge 23 of the nutrient basin 10. The one or more plant-holding structures 30 are placed on top of the first guide 20A and the second guide 20B perpendicular to the longitudinal direction 21, as can be seen in FIG. 3C.

The first guide 20A comprises a first displacement bar 370A. The second guide 20B comprises a second displacement bar 370B. The first displacement bar 370A and the second displacement bar 370B are accommodated within the U-shaped cross-section of the first and second guide 20A, 20B and can be moved along the longitudinal direction 21. The first displacement bar 370A and the second displacement bar 370B may be moved, for example, but not limited to, 2.5 m back and forth. In one example, one end of the first displacement bar 370A and the second displacement bar 370B contacts the first edge 22 of the nutrient basin 10.

A first plurality of displacement devices 325 is mounted on top of the first displacement bar 370A and a second plurality of displacement devices 325 is mounted on top of the second displacement bar 370B. The first plurality of displacement devices 325 and the second plurality of displacement devices 325 may exhibit an equidistant spacing along the longitudinal direction 21. A value of the equidistant spacing between ones of the first and second plurality of displacement devices 325 may be, for example, but not limited to, 5 m. It will be understood that other values of the equidistant spacing may also be selected, for example, a value smaller than 5 m, such as 2.5 m, or a value larger than 5 m, such as 7.5 m. Positions of the first plurality of displacement devices 325 correspond to positions of the second plurality of displacement devices 325 along the longitudinal direction 21. Each one of the displacement device 325 comprises the engagement element 310. The engagement element 310 is movable. The engagement element 310 may be, for example, but not limited to, a mechanical finger which is configured to be elevated for engaging with the one or more plant-holding structures 30. Elevating the mechanical finger may be performed, for example, by an electromagnet. The electromagnet may be controlled electrically. It will be appreciated that other embodiments of the engagement element 310 may also be used, for example, as described above or discussed with respect to FIG. 3A.

It is noted that the first plurality of displacement devices and the second plurality of displacement devices 325 may further comprise a sensor for monitoring a position of the mechanical finger. The sensor may provide position data about the mechanical finger, for example, to the PLC, as discussed above. The PLC may also be connected to the first plurality of displacement devices and the second plurality of displacement devices 325 and configured to operate the engagement elements 310. The PLC is configured to operate two corresponding engagement elements 310, i.e., one of the first plurality of displacement devices 325 and one of the second plurality of displacement devices 325 exhibiting an equal position along the longitudinal direction 21.

FIG. 3D shows the driving mechanism 350 for driving the first displacement bar 370A. The driving mechanism 350 applies analogously to the second displacement bar 370B. The driving mechanism comprises a motor (not shown in FIG. 3C or FIG. 3D). The motor may be installed at the lateral side 24 of the nutrient basin 10, for example, at a greenhouse pillar 352. The motor provides torque for driving a drive shaft 360. The drive shaft 360 is arranged, for example, parallel to the first edge 22 of the nutrient basin 10 and located, for example, between the first edge 22 and the second edge 23. The drive shaft 360 is coupled to the motor and extends into the nutrient basin 10 and into the first guide 20A and the second guide 20B by means of, for example, through holes. The drive shaft is enclosed by a drive shaft housing 372. The drive shaft housing 372 seals the through holes to the surrounding so that the nutrient medium 12 cannot enter the first guide 20A and/or the second guide 20B and/or cannot leave the nutrient basin 10. The drive shaft 360 comprises a first pinion 380A which is located inside the first guide 20A. The first pinion 380A is fixed to the drive shaft 360 and engages a first rack 382A. The first rack 382A is mounted to the bottom side of the first displacement bar 370A, see FIG. 3D. The drive shaft 360 also comprises a second pinion 380B which is located inside the second guide 20B. The second pinion 380B is also fixed to the drive shaft 360 and engages a second rack 382B. The second rack 382B is mounted to the bottom side of the second displacement bar 370B. The first rack 382A and the second rack 382B is located at a rack position 381 corresponding to the location of the drive shaft 360, i.e., between the first edge 22 and the second edge 23. The first rack 382A and the second rack 382B may have, for example, a length of 5 m. It will be appreciated that the length may also be larger or smaller than 5 m.

It is noted that the motor can be connected to the PLC. The PLC can thus control a movement of the first displacement bar 370A and the second displacement bar 370B, i.e., the movement of the first and second plurality of displacement devices 325 for moving the one or more plant-holding structures 30. The driving mechanism 350, as discussed above, enables a precise displacement of the one or more plant-holding structures 30 in a synchronized manner and without any cables. Furthermore, only one motor is required which reduces investment costs.

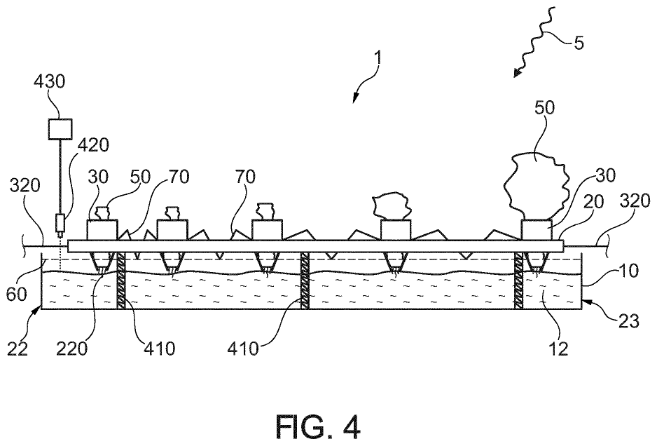

FIG. 4 shows the plant cultivation system 1 from a side view of FIG. 1A. The same reference numerals are used in FIG. 4 and FIG. 1A to define similar elements. The plant holding structures 30 are placed on top of the guide 20, wherein the spacing between adjacent plant-holding structures 30 depends on the degree of growth of the plants 50. Guide supports 410 are provided to mount the guides 20 above the surface of the nutrient basin 10. As noted above, the coverings 70 are additionally provided between adjacent plant-holding structures 30 shielding the nutrient medium 12 from light 5. The coverings 70 are supported by the support lines 60, which are stretched from the first edge 22 to the second edge 23 of the nutrient basin 10. The coverings 70 are configured to slide over the support lines 60 in the case that a plant-holding structures 30 is moved. In the case where the nutrient medium 12 is a fluid, a gauge 420 for measuring the level of the surface of the nutrient medium 12 determines the level of the nutrient medium 12 within the nutrient basin 10. It is possible to change the level 240 of the fluid forming the nutrient medium 12 and thus enable control of the accessibility for the roots 220 to the fluid with the nutrient medium 12. This procedure is actively used to promote development of the roots 220 of plants 50 (in particular younger plants such as seedlings) during the first days and weeks of the growth cycle.

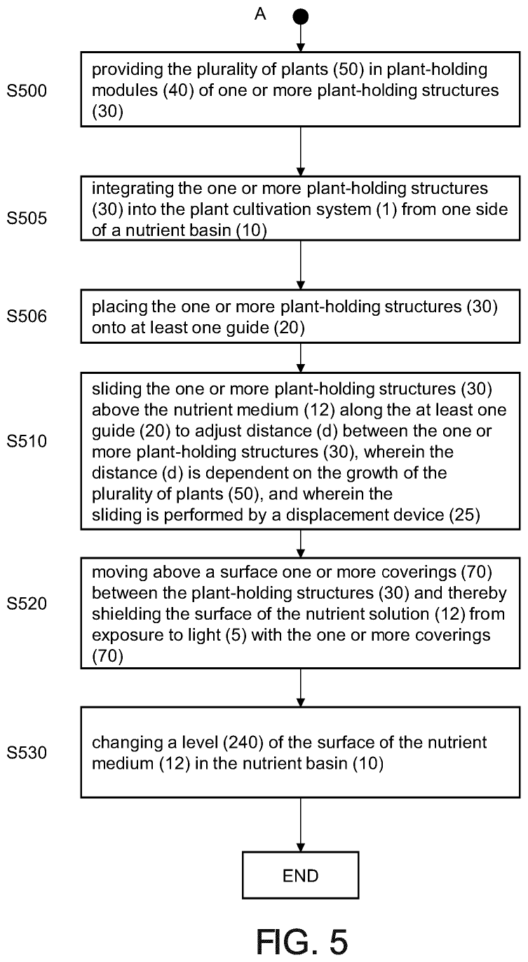

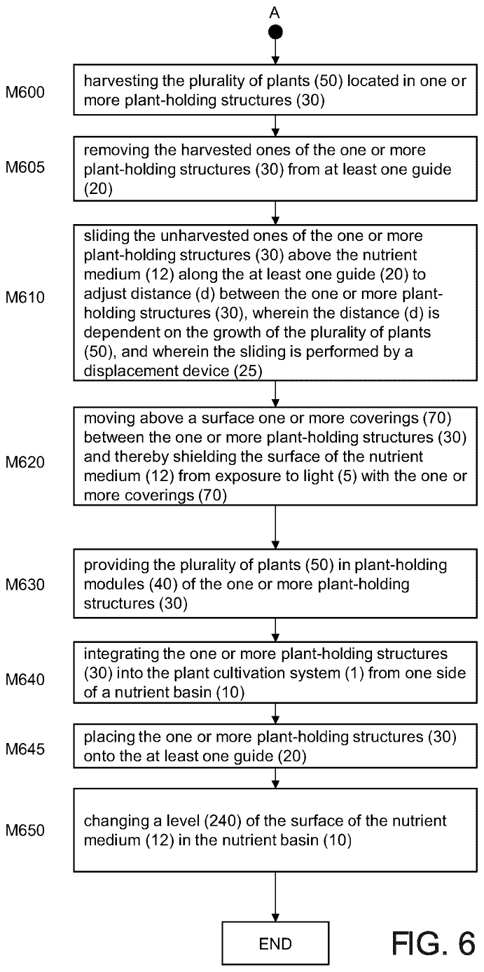

FIG. 5 shows a flow chart describing a method S for using the plant cultivation system 1 to cultivate the plants 50. In a first step S500, a plurality of the plants 50 are mounted in the plant-holding structures 30. This first step S500 comprises, for example, placing one or more younger plants 50 in the accommodating spaces of the plant-holding module 40, such as shown in FIG. 2A. The plant-holding structures 30 carrying younger plants 50 are then integrated in step S505 into the plant cultivation system 1 from one side, for example from the first edge 22 of the nutrient basin 10 and placed onto the guides 20 (step S506). The plant-holding structures 30 are moved over time along the nutrient basin 10 and a second step S510 describes the procedure of sliding the plant-holding structures 30 above the nutrient medium 12 along the guides 20. The distance d between adjacent ones of the plant-holding structures 30 depends on the growth of the plants 50 and is increased as the plants 50 grow larger. The plants 50 are fed from the nutrient medium 12 during the growth period. When the spacing of the plant-holding structures 30 is adjusted, the coverings 70 between adjacent ones of the plant-holding structures 30 need to be moved accordingly for shielding the surface of the nutrient medium 12 from exposure to the light 5. This is described by step S520 of the flow chart in FIG. 5.

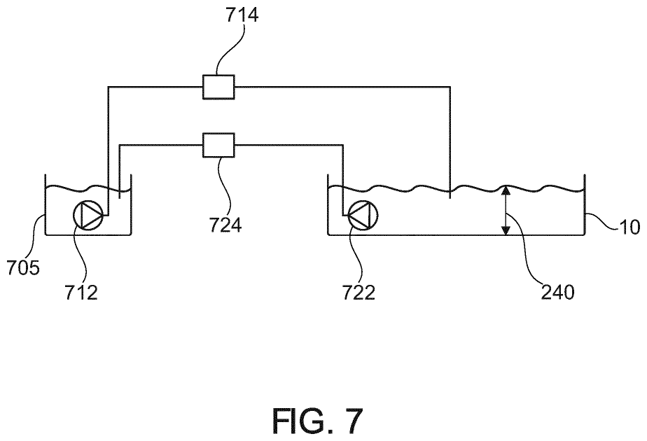

FIG. 6 shows a flow chart describing a method M for using the plant cultivation system 1 to cultivate the plants 50. The method M describes a scenario in which a plurality of the plant-holding structures 30 is disposed on a plurality of the guides 20 and one or more of the plants 50 (located in the one or more plant-holding structures 30) are ready for harvesting (e.g., the older ones of the plants 50). The plant-holding structures 30 carrying the older plants 50 are typically located closer to the second edge 23 of the nutrient basin 10, as depicted in FIG. 1A. In a first step M600 of method M, one or more of the plants 50 (e.g., the older plants) can be harvested leaving remains, such as roots, in the plant-holding structures 30. The plant-holding structures 30 with the remains of the harvested plants 50 can subsequently be removed from the guides 20.

A second step M610 comprises sliding of the plant-holding structures 30 holding the non-harvested plants 50 and the adjusting of the distance d between the plant-holding structures 30, as discussed with respect to FIG. 5, step S510. A third step M620 describes the moving of the one or more coverings 70 between the plant-holding structures 30, as discussed with respect to FIG. 5, step S520.

Step M630 comprises placing younger plants 50 into the plant-holding modules 40 of the plant-holding structures 30 so that the plant-holding structures 30 carrying the younger plants 50 can then be integrated in step M640 into the plant cultivation system 1 from one side of the nutrient basin 10 and can be placed on the plurality of the guides 20 (step M645).

The plants 50 are fed from the nutrient medium 12. As noted above, the level 240 of the nutrient medium 12 in the nutrient basin 10 can be changed in step S530 of FIG. 5 or M650 of FIG. 6 by adding or removing the nutrient medium 12 from the nutrient basin 10 to promote the growth of the plants.

The process of providing or removing the nutrient medium 12 from the nutrient basin 10 can be implemented, for instance, by one or more pumps and a connected buffer basin (not shown in the FIGS. 1 to 4). The buffer basin may also comprise the nutrient medium 12.

In one embodiment for adding or removing the nutrient medium 12 to or from the nutrient basin 10, two pumps and two solenoid valves are implemented, as can be seen in FIG. 7. A first pump 712 is capable of transferring the nutrient medium 12 from the buffer basin 705 to the nutrient basin 10 for providing additional nutrient medium 12, i.e., increasing the level of the surface of the nutrient medium 240. A first solenoid valve 714 ensures flow of the nutrient medium 12 only towards the nutrient basin 10. The first solenoid valve 714 also prevents backflow from the nutrient basin 10 to the buffer basin 705. A second pump 722 is capable of transferring the nutrient medium 12 from the nutrient basin 10 to the buffer basin 705 for removing the nutrient medium 12, i.e., decreasing the level of the surface of the nutrient medium 240. A second solenoid valve 724 ensures flow of the nutrient medium 12 only towards the buffer basin 705. The second solenoid valve 724 also prevents backflow from the buffer basin 705 to the nutrient basin 10.

It will be understood that the adding or the removing of the nutrient medium 12 to or from the nutrient basin 10, i.e., changing of the level of the nutrient medium 12, as discussed above, may also be implemented by using a single pump capable of switching a pump direction, for example, a peristaltic pump or an impeller pump.

The level of the surface of the nutrient medium 12 can be determined by a monitoring device 430 depending on several parameters and settings, such as a set minimum height of the level of the surface, the current level obtained by the gauge 420 for measuring the level of the surface of the nutrient medium 12, the length of the roots 220, and the degree of growth of the plants 50. The monitoring device 430 then triggers a corresponding signal for starting the one or more pumps to provide additional nutrient medium 12 or remove nutrient medium 12 from the nutrient basin 10. The manual operation of the pump by a user is also possible.

In a further embodiment, a pressure sensor derives the level of the surface of the nutrient medium 240 by measuring the pressure exerted by the nutrient medium 12 in the nutrient basin 10. The pressure sensor provides pressure data which can be converted to corresponding levels of the surface of the nutrient medium 12, i.e., heights. The pressure sensor may be, for example, a KELLER 46X Series sensor.

The method described in FIG. 5 or FIG. 6 can be implemented using a computer program. Users may change the operation of the computer program by changing input parameters for moving the plant-holding structures 30. For example, the increase of the distance d between adjacent plant-holding structures 30 over time and stage of growth may be specified. This input is then processed and executed by the software controller. The software controller then provides corresponding instructions to the displacement device 25 for moving the plant-holding structures 30 to the right position at the right time.

In one embodiment, the PLC may be provided with the pressure data obtained from the pressure sensor. The PLC controls the first and second pump as well as the first and second solenoid valve for increasing or decreasing the level of the surface of the nutrient medium 240 based on the processed pressure data. The first and second pump may be, for example, Grundfos UNILIFT AP12 pumps. The PLC may for example comprise a Siemens type SIMATIC ET 200SP PLC. The Siemens SIMATIC ET 200SP PLC may, for example, allow the user to input parameters such as, but not limited to, height of a low level of the surface of the nutrient medium 240, height of a high level of the surface of the nutrient medium 240, duration of the low level, duration of the high level, and regulation tolerances for the heights of the low level and the high level.

The PLC is capable of automatically controlling the first and second pump as well as the first and second solenoid valve to execute desired cycles per day regarding different levels of the surface of the nutrient medium 240. A number of cycles per day may, for example, be determined by the evaporation rate of the nutrient medium 12 which is a function of air temperature and relative humidity. The number of cycles per day may also be determined such that the lower part of the plant 50 (usually a ball of earth with roots, or the like) never completely dries out.

### REFERENCE NUMERALS

1 Plant cultivation system
5 Light
10 Nutrient basin
12 Nutrient medium
14 First region of the nutrient basin
16 Second region of the nutrient basin
20 Guide
20A First guide
20B Second guide
21 Longitudinal direction
22 First edge
23 Second edge
24 Lateral side
25,325 Displacement device
26 Direction of movement
30 Plant-holding structure
30A First plant-holding arrangement
30B Second plant-holding arrangement
40 Plant-holding module
50 Plant
60 First support line
60′ Second support line
70 Covering
210 Guiding element
220 Root
230 Holding element
240 Level of the surface of the nutrient medium
242A First vertical distance between surface of the nutrient medium and the guide
242B Second vertical distance between surface of the nutrient medium and the guide
250 Bottom part of a plant-holding module
310 Engagement element
311 Wheel
312 Controlling motor
313 Angle sensor unit
314 Tension unit
320 Cable loop
321 Engagement direction
322 Opening
350 Driving mechanism
352 Greenhouse pillar
360 Drive shaft
370A First displacement bar
370B Second displacement bar
372 Drive shaft housing
380A First pinion
380B Second pinion
381 Rack position
382A First rack
382B Second rack
330 End sensor
410 Guide support
420 Gauge for measuring the level of the surface of the nutrient medium
430 Monitoring device
705 Buffer basin
712 First pump
722 Second pump
714 First solenoid valve
724 Second solenoid valve
D0 Initial distance
α Slope angle
d Distance
S Method
M Method

1. A plant cultivation system for the cultivation of plants comprising:
a nutrient basin provided with a nutrient medium;
at least one guide arranged to be mounted above the nutrient basin, wherein the at least one guide comprises one or more portions arranged parallel to the surface of the nutrient medium, or at a slope angle (a) for increasing a vertical distance between the surface of the nutrient medium and the at least one guide;
one or more plant-holding structures for holding a plurality of the plants and being configured to slide along the at least one guide, wherein
the at least one guide comprises a displacement device) for moving at least one of the one or more plant-holding structures and adjusting a distance (d) between the one or more plant-holding structures, and wherein the distance (d) is dependent on the growth of the plants; and
one or more coverings for shielding the surface of the nutrient medium from exposure to light.

2. The plant cultivation system according to claim 1, further comprising at least one pump for changing a level of the surface of the nutrient medium.

3. The plant cultivation system according to claim 2, further comprising at least one of a gauge or a pressure sensor for measuring a height of the level of the surface of the nutrient medium.

4. The plant cultivation system according to claim 1, wherein the nutrient basin is divided into multiple sections.

5. The plant cultivation system according to claim 1, wherein the nutrient basin comprises a plurality of nutrient basins which are adjacently arranged.

6. The plant cultivation system according to claim 1, wherein
the at least one guide is adapted to comprise an accommodating guide for accommodating the displacement device and comprises at least two support guides, and wherein the at least two support guides are arranged adjacently to the accommodating guide for supporting the one or more plant-holding structures.

7. The plant cultivation system according to claim 1, wherein
the at least one guide is adapted to comprise at least one of a first guide comprising a first displacement bar and at least one of a second guide comprising a second displacement bar, wherein the displacement device comprises a first plurality of displacement devices mounted on the first displacement bar and a second plurality of displacement devices mounted on the second displacement bar;
wherein the plant cultivation system further comprises a drive shaft coupled to the first displacement bar and the second displacement bar for moving the first displacement bar and the second displacement bar in a synchronized manner; and
a motor coupled to the drive shaft for driving the drive shaft.

8. The plant cultivation system according to claim 7, wherein ones of the first plurality of displacement devices and the second plurality of displacement devices comprise a movable engagement element using an electrically controlled electromagnet for engagement with the one or more plant-holding structures.

9. The plant cultivation system according to claim 1, further comprising at least one first support line for supporting the one or more coverings.

10. (canceled).

11. (canceled).

12. The plant cultivation system according to claim 1, wherein the one or more plant-holding structures are equipped with one or more plant-holding modules.

13. The plant cultivation system according to claim 12, wherein adjacent ones of the one or more plant-holding structures comprise a first plant-holding arrangement and a second plant-holding arrangement for forming a staggered disposition of the one or more plant-holding modules, and wherein the adjacent ones of the one or more plant-holding structures further comprise differentiated end caps, preferably coloured end caps, for differentiating the first plant-holding arrangement from the second plant-holding arrangement.

14. The plant cultivation system according to claim 10, wherein the one or more plant-holding modules are configured to be an integral part of a plant-holding structure.

15. (canceled).

16. (canceled).

17. (canceled).

18. (canceled).

19. (canceled).

20. The plant cultivation system according to claim 1, wherein a number of the one or more guides arranged in a first region of the nutrient basin is different to a number of the one or more guides arranged in a second region of the nutrient basin.

21. The plant cultivation system according to claim 13, wherein adjacent ones of the one or more guides arranged in the first region of the nutrient basin exhibit a first spacing and adjacent ones of the one or more guides arranged in the second region of the nutrient basin exhibit a second spacing, wherein the first spacing is smaller than the second spacing.

22. The plant cultivation system according to claim 1, wherein the displacement device is accommodated in the at least one guide for moving at least one of the one or more plant-holding structures.

23. The plant cultivation system according to claim 1, wherein the displacement device comprises a/the moveable engagement element for engagement with the one or more plant-holding structures.

24. The plant cultivation system according to claim 1, wherein the one or more coverings are attached to the one or more plant-holding structures and are displaceable along at least one guide.

25. The plant cultivation system according to claim 1, wherein the displacement device further comprises a controlling motor for actioning a cable loop, and a tension unit configured to move the displacement device and to adjust distance (d) between the one or more plant-holding structures.

26. (canceled).

27. (canceled).

28. The plant cultivation system according to claim 10, wherein the one or more plant-holding modules are configured to hold a plant, wherein the plant is feedable from the nutrient medium of the nutrient basin.

29. The plant cultivation system according to claim 1, wherein the one or more coverings exhibit a foldable structure and are made of at least one of plastics, aluminized paper, stainless steel, aluminium, or aluminized plastic.

30. The plant cultivation system according to claim 1, wherein the nutrient medium is at least one of a fluid or a mist.

31. (canceled).

32. (canceled).

33. (canceled).

34. (canceled).

35. A method for the cultivation of a plurality of plants in a nutrient medium in a plant cultivation system comprising the following steps:
providing the plurality of plants in plant-holding modules of one or more plant-holding structures;
integrating the one or more plant-holding structures into the plant cultivation system from one side of a nutrient basin;
placing the one or more plant-holding structures onto at least one guide;
sliding the one or more plant-holding structures above the nutrient medium along the at least one guide to adjust distance (d) between the one or more plant-holding structures, wherein the distance (d) is dependent on the growth of the plurality of plants, and wherein the sliding is performed by a displacement device; and
moving above a surface one or more coverings between the plant-holding structures and thereby shielding the surface of the nutrient medium from exposure to light with the one or more coverings.

36. A method for the cultivation of a plurality of plants in a nutrient medium in a plant cultivation system comprising the following steps:
harvesting the plurality of plants located in one or more plant-holding structures;
removing the harvested ones of the one or more plant-holding structures from at least one guide;
sliding the unharvested ones of the one or more plant-holding structures above the nutrient medium along the at least one guide to adjust distance (d) between the one or more plant-holding structures, wherein the distance (d) is dependent on the growth of the plurality of plants, and wherein the sliding is performed by a displacement device;
moving above a surface one or more coverings between the one or more plant-holding structures and thereby shielding the surface of the nutrient medium from exposure to light with the one or more coverings;
providing the plurality of plants in plant-holding modules of the one or more plant-holding structures;
integrating the one or more plant-holding structures into the plant cultivation system from one side of a nutrient basin; and
placing the one or more plant-holding structures onto the at least one guide.

37. The method according to claim 35, further comprising changing a level of the surface of the nutrient medium in the nutrient basin.

38. The method according to claim 35, further comprising engaging a displacement device with the one or more plant-holding structures; and
displacing the displacement device along the at least one guide.

39. (canceled).
